(19) United States
(12) Patent Application Publication
(10) Pub. No.: US 2018/0294446 A1
(43) Pub. Date: Oct. 11, 2018

(54) ELECTRIC STORAGE DEVICE AND METHOD FOR MANUFACTURING THE SAME

(71) Applicant: Murata Manufacturing Co., Ltd., Nagaokakyo-shi (JP)

(72) Inventor: YUJI KIMURA, Nagaokakyo-shi (JP)

(21) Appl. No.: 16/007,031

(22) Filed: Jun. 13, 2018

Related U.S. Application Data
(63) Continuation of application No. PCT/JP2017/000150, filed on Jan. 5, 2017.

(30) Foreign Application Priority Data
Jan. 16, 2016 (JP) 2016-006707
Jan. 18, 2016 (JP) 2016-007454

(51) Int. Cl. H01M 2/02; B23K 26/21; B23K 26/244; H01M 2/08; H01G 11/78; H01G 11/84

(52) U.S. Cl. CPC H01M 2/0257; B23K 26/21; H01G 11/84; H01M 2/08; H01G 11/78; B23K 26/244

(57) ABSTRACT

A miniaturized electric storage device having a first case piece and a second case piece joined by welding over the entire periphery at an overlapping portion of a first side wall portion and a second side wall portion. Of the welded portions formed on the side surfaces of the case, the width of the welded portion formed on the corner portions of the case is smaller than the width of the welded portion formed on the side surfaces of the case.

### CROSS REFERENCE TO RELATED APPLICATIONS

The present application is a continuation of International application No. PCT/JP2017/000150, filed Jan. 5, 2017, which claims priority to Japanese Patent Application No. 2016-006707, filed Jan. 16, 2016, and Japanese Patent Application No. 2016-007454, filed Jan. 18, 2016, the entire contents of each of which are incorporated herein by reference.

### FIELD OF THE INVENTION

The present invention relates to an electric storage device and a method for manufacturing the electric storage device.

### BACKGROUND OF THE INVENTION

Conventionally, electric storage devices have been used as power supplies for various electronic apparatuses. For example, Patent Document 1 describes a battery in which an electrode body is accommodated in a battery can formed by welding a can main body provided with a flange portion at a peripheral portion and a metal lid at the flange portion.

Patent Document 1: Japanese Patent Application Laid-Open No. 2004-6226

### SUMMARY OF THE INVENTION

In recent years, miniaturization of electronic apparatuses has advanced, and demands for miniaturization of electric storage devices have increased accordingly.

A main object of the present invention is to provide a miniaturized electric storage device.

The electric storage device according to the present invention includes a case and an electric storage device main body. The case has a corner portion having a rounded shape in a plane view. The electric storage device main body is disposed in the case. The case includes a first case piece and a second case piece. The second case piece and the first case piece form the case. The first case piece includes a first wall portion and a first side wall portion that extends from the entire periphery of the first wall portion. The second case piece includes a second wall portion and a second side wall portion that extends from the entire periphery of the second wall portion. The second side wall portion overlaps with the first side wall portion. The first case piece and the second case piece are welded over the entire periphery in a portion where the first side wall portion and the second side wall portion are overlapped. Of the welded portion formed on a side surface of the case, the width of the welded portion formed on the corner portion of the case is smaller than the width of the welded portion formed on the side surface of the case.

In the electric storage device according to the present invention, the first side wall portion and the second side wall portion are welded. Therefore, it is unnecessary to provide a flange portion in the can main body as in the battery described in Patent Document 1. Therefore, the electric storage device according to the present invention has a small size.

In the electric storage device according to the present invention, it is preferable that the welded portion is formed so that the tip portions of the welded portions on the side surfaces of the case overlap each other on the corner portions of the case.

In the electric storage device according to the present invention, the welded portion may include a first welded portion provided on a first side surface of the case, a second welded portion provided on a second side surface of the case, a third welded portion provided on a third side surface of the case, and a fourth welded portion provided on a fourth side surface of the case. One side end portion of the first welded portion and one side end portion of the second welded portion may overlap on a first corner portion connecting the first side surface and the second side surface of the case, another side end portion of the first welded portion and one side end portion of the third welded portion may overlap on a second corner portion connecting the first side surface and the third side surface of the case, another side end portion of the second welded portion and one side end portion of the fourth welded portion may overlap on a third corner portion connecting the second side surface and the fourth side surface of the case, and another side end portion of the third welded portion and another side end portion of the fourth welded portion may overlap on a fourth corner portion connecting the third side surface and the fourth side surface of the case.

In the electric storage device according to the present invention, it is preferable that each of the first and second case pieces is formed of a metal plate having a thickness of 50 μm to 200 μm.

In the electric storage device according to the present invention, the electric storage device main body may contain an electrolytic solution.

The method for manufacturing an electric storage device according to the present invention relates to a method for manufacturing an electric storage device including a case having a corner portion having a rounded shape in a plane view and an electric storage device main body disposed inside the case. The method for manufacturing an electric storage device according to the present invention includes, in a state in which a first case piece including a first wall portion and a first side wall portion extending from an entire periphery of the first wall portion and a second case piece including a second wall portion and a second side wall portion extending from an entire periphery of the second wall portion are disposed so that the first side wall portion and the second side wall portion overlap each other, then laser-welding an overlapping portion of the first side wall portion and the second side wall portion over an entire periphery of the case so that a width of the welded portion formed on the corner portion of the case is smaller than a width of the welded portion formed on the side surface of the case.

In the method for manufacturing an electric storage device according to the present invention, in the welding step, of the welded portion formed on the side surface of the case, the laser-welding is performed so that a width of the welded portion formed on the corner portion of the case is smaller than a width of the welded portion formed on the side surface of the case. In the case of laser-welding, the size of the welding trace (the area and the depth on the surface side) is determined by the beam diameter, energy, and irradiation time of the laser beam. In the welded portion, the fact that the welding traces are continuously formed into a band shape and the width of the welded portion becomes narrower indicates that the size of individual welding traces of that portion becomes smaller. For this reason, damage due to laser-welding in the corner portions of the case in which heat is easily trapped and which is easily damaged during laser-welding can be reduced. Therefore, even if a flange portion for welding to the case is not provided, the first case piece and the second case piece can be suitably welded, and the case can be manufactured. Therefore, according to the method for manufacturing an electric storage device according to the present invention, a miniaturized electric storage device can be suitably manufactured.

In the method for manufacturing an electric storage device according to the present invention, in the welding step, it is preferable to perform laser-welding so that the tip portions of the welded portion overlap each other on the corner portion of the case.

In the method for manufacturing an electric storage device according to the present invention, in the welding step, laser-welding may be performed so that the tip portions of the welded portion overlap each other on each corner portion of the case.

According to the present invention, a miniaturized electric storage device can be provided.

### BRIEF EXPLANATION OF THE DRAWINGS

FIG. 1 is a schematic perspective view of an electric storage device according to an embodiment of the present invention.

FIG. 2 is a schematic plan view of the electric storage device according to the embodiment of the present invention.

FIG. 3 is a schematic cross-sectional view taken along line III-III in FIG. 1.

FIG. 4 is a schematic cross-sectional view taken along line IV-IV in FIG. 1.

FIG. 5 is a schematic perspective view when viewed from the direction of an arrow V in FIG. 1.

FIG. 6 is a schematic plane view when viewed from the direction of the arrow V in FIG. 1.

FIG. 7 is a schematic perspective view when viewed from the direction of an arrow VI in FIG. 1.

FIG. 8 is a schematic plane view when viewed from the direction of the arrow VI in FIG. 1.

FIG. 9 is a schematic perspective view when viewed from the direction of an arrow IX in FIG. 1.

FIG. 10 is a schematic plane view when viewed from the direction of the arrow IX in FIG. 1.

FIG. 11 is a schematic perspective view when viewed from the direction of an arrow XI in FIG. 1.

FIG. 12 is a schematic plane view when viewed from the direction of the arrow XI in FIG. 1.

### DETAILED DESCRIPTION OF THE INVENTION

In the following, an exemplary preferred embodiment of the present invention will be described. However, the following embodiment is merely an example. The present invention is not limited to the following embodiment at all.

In addition, in the each of the drawings referred to in the embodiment or the like, members having substantially the same functions are denoted by the same reference numerals. In addition, the drawings referred to in the embodiment or the like are schematically described. The dimension ratio or the like of an object drawn in the drawing may differ from the dimension ratio or the like of an actual object. The dimension ratio of an object may differ even between the drawings. A specific dimension ratio or the like of an object should be determined in consideration of the following description.

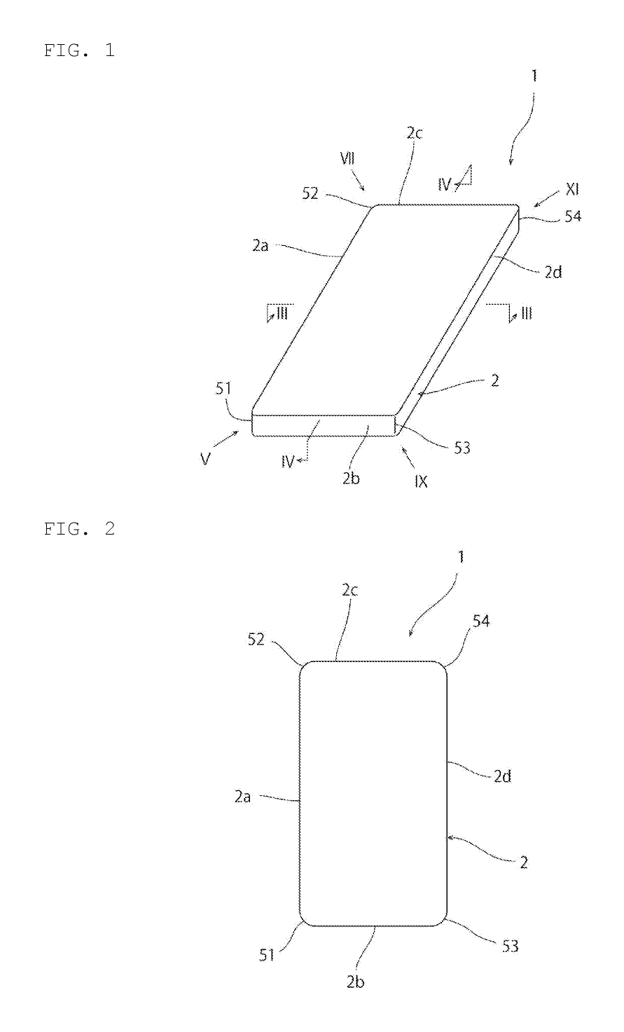

FIG. 1 is a schematic perspective view of an electric storage device according to the present embodiment.

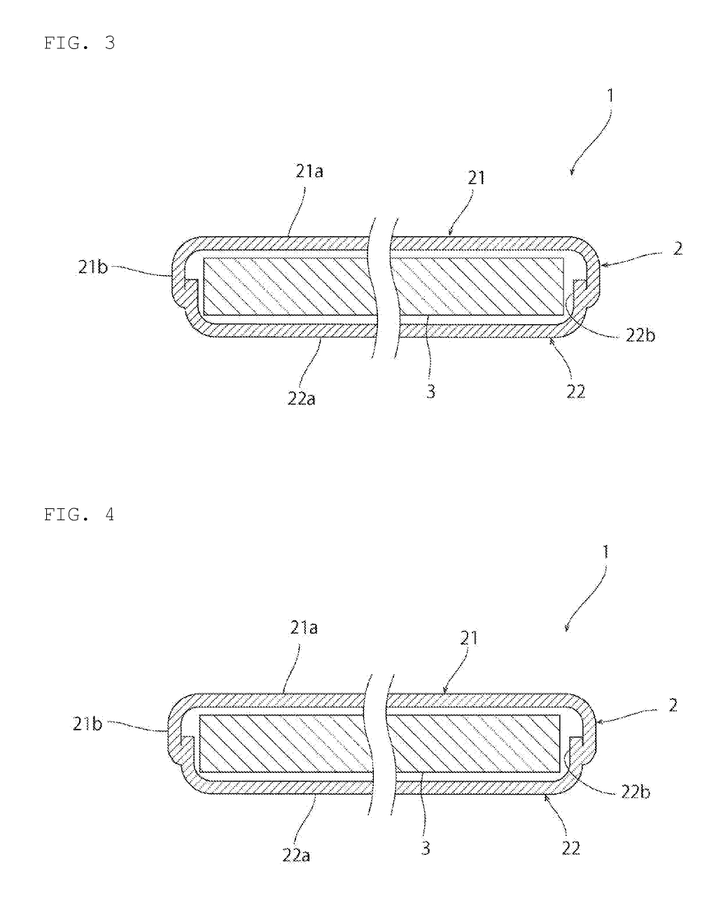

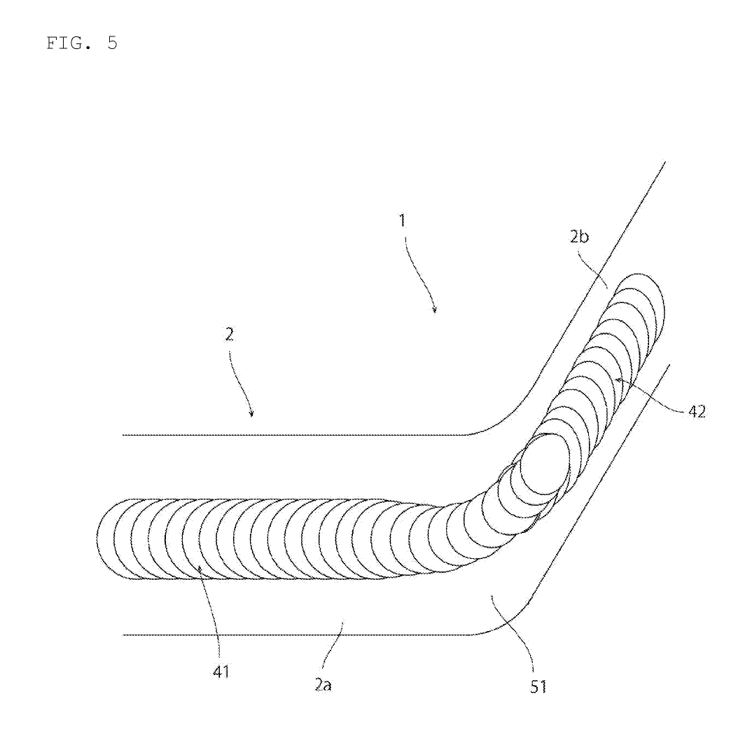

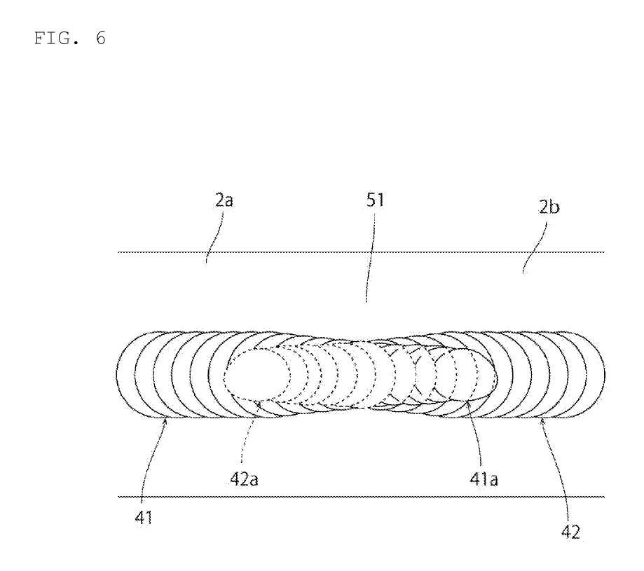

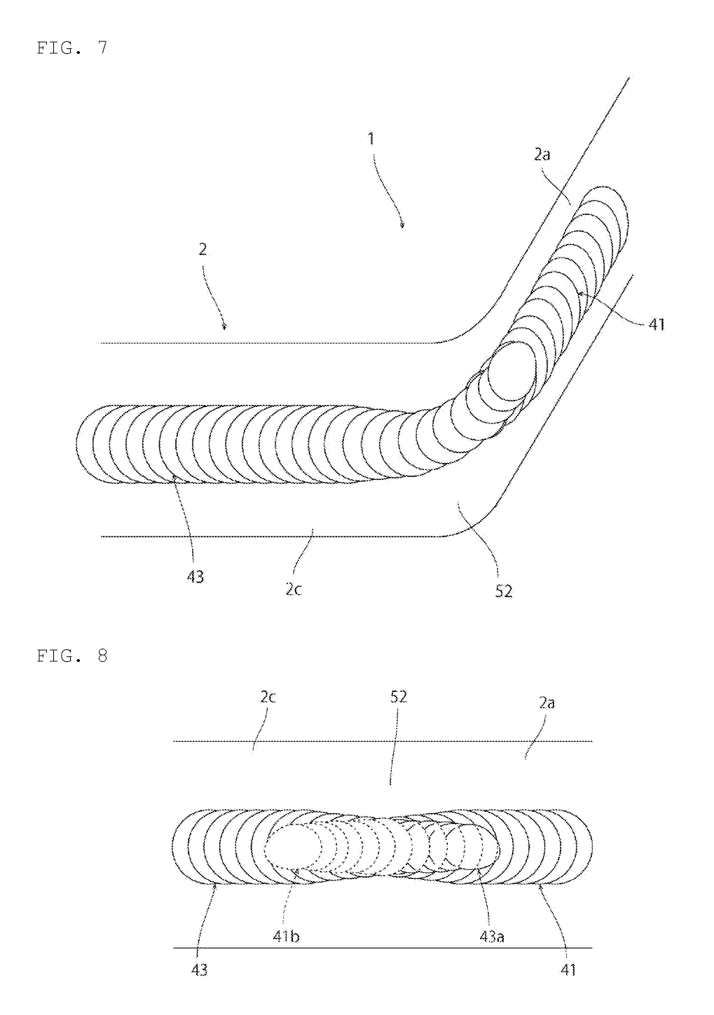

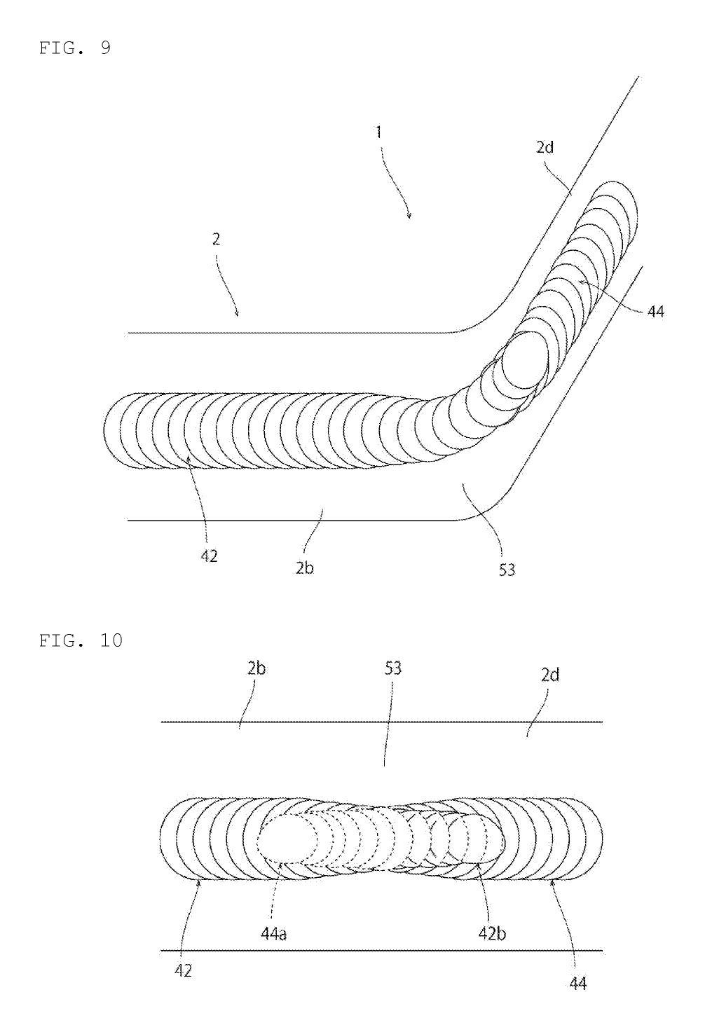

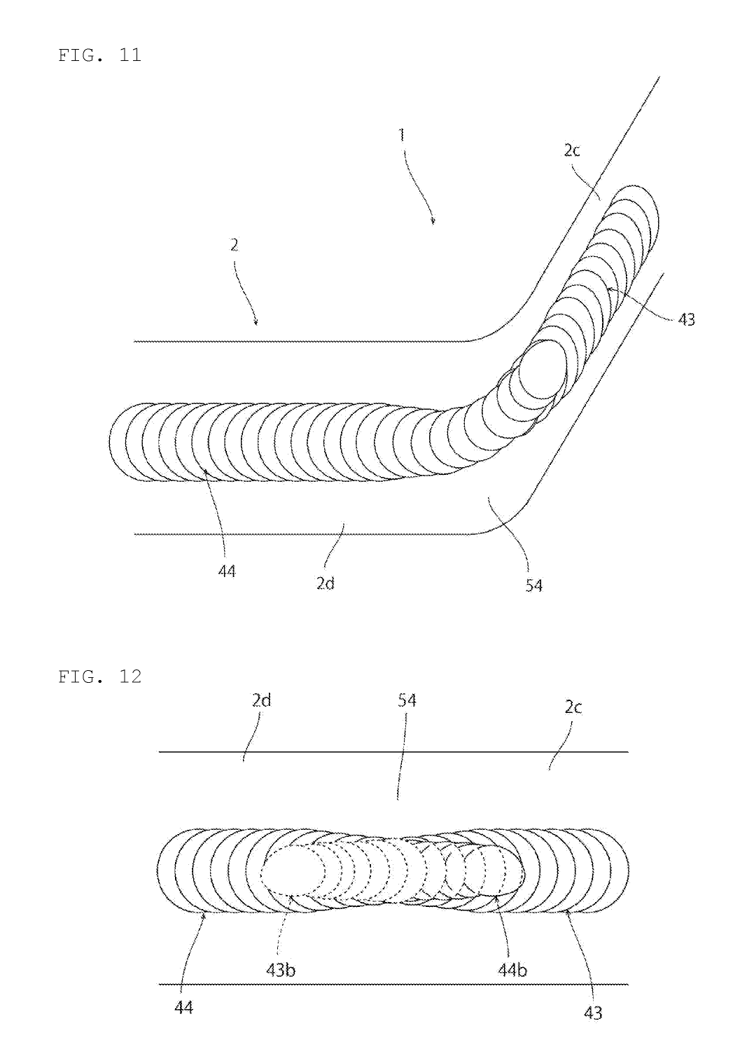

FIG. 2 is a schematic plane view of the electric storage device according to the present embodiment. FIG. 3 is a schematic cross-sectional view taken along line III-III in FIG. 1. FIG. 4 is a schematic cross-sectional view taken along line IV-IV in FIG. 1. FIG. 5 is a schematic perspective view when viewed from the direction of an arrow V in FIG. 1. FIG. 6 is a schematic plane view when viewed from the direction of the arrow V in FIG. 1. FIG. 7 is a schematic perspective view when viewed from the direction of an arrow VI in FIG. 1. FIG. 8 is a schematic plane view when viewed from the direction of the arrow VI in FIG. 1. FIG. 9 is a schematic perspective view when viewed from the direction of an arrow IX in FIG. 1. FIG. 10 is a schematic plane view when viewed from the direction of the arrow IX in FIG. 1. FIG. 11 is a schematic perspective view when viewed from the direction of an arrow XI in FIG. 1. FIG. 12 is a schematic plane view when viewed from the direction of the arrow XI in FIG. 1.

As shown in FIGS. 3 and 4, an electric storage device 1 includes a case 2 and an electric storage device main body 3.

The electric storage device main body 3 is not particularly limited as long as it can store electric power. For example, the electric storage device main body 3 may be a battery such as a secondary battery, a capacitor such as an electric double layer capacitor, or the like. The electric storage device main body 3 may be provided with an electrolytic solution. In the electric storage device including the electrolytic solution, the electrolytic solution may react to a high temperature to decompose, but according to the present invention, adverse effects on the electrolytic solution due to the surplus energy of the laser can be reduced, so that the present invention is suitable for an electric storage device including an electrolytic solution.

As shown in FIG. 2, in the present embodiment, the case 2 has a rectangular shape in which each of the four corner portions is rounded in a plane view. That is, the case 2 is substantially a rectangular parallelepiped having a shape in which each of the corner portions is rounded. However, in the present invention, the shape of the case is not limited to a rectangular shape having rounded corner portions in a plane view. The case is not particularly limited as long as it has a shape having corner portions having a rounded shape. For example, in a plane view, the case may have a rectangular shape with one corner portion provided with a rectangular notch and the other corner portions rounded.

As shown in FIGS. 3 and 4, the case 2 includes a first case piece 21 and a second case piece 22 welded to each other. The first case piece 21 and the second case piece 22 constitute the case 2.

The first case piece 21 includes a first wall portion 21a and a first side wall portion 21b. The first wall portion 21a has a rectangular shape in which each of the four corner portions is rounded. The first side wall portion 21b extends from the entire periphery of the first wall portion 21a. Specifically, the first side wall portion 21b extends in a direction perpendicular to the first wall portion 21a toward the second case piece 22 from the entire periphery of the peripheral edge portion of the first wall portion 21a.

The second case piece 22 includes a second wall portion 22a and a second side wall portion 22b. The second wall portion 22a has a rectangular shape in which each of the four corner portions is rounded. The second side wall portion 22b extends from the entire periphery of the peripheral edge portion of the second wall portion 22a. Specifically, the second side wall portion 22b extends in a direction perpendicular to the second wall portion 22a toward the first case piece 21 from the entire periphery of the second wall portion 22a.

The first case piece 21 and the second case piece 22 are disposed so that at least a part of the first side wall part 21b and at least a part of the second side wall portion 22b overlap each other in the thickness direction of the side wall portions 21b and 22b. The first case piece 21 and the second case piece 22 are joined by welding over the entire periphery at the overlapping portion of the first side wall portion 21b and the second side wall portion 22b. In the present embodiment, specifically, the first case piece 21 and the second case piece 22 are welded over the entire periphery with a part of the first side wall portion 21b and a part of the second side wall portion 22b positioned so as to overlap in the thickness direction of the side wall portions 21b and 22b.

The material of the first case piece 21 and the second case piece 22 is not particularly limited. Each of the first case piece 21 and the second case piece 22 can be made of a metal such as aluminum, aluminum alloy, or stainless steel, for example.

The thickness of each of the first case piece 21 and the second case piece 22 is preferably small within a range that can secure the strength required for the case 2 from the viewpoint of miniaturizing the electric storage device 1. Specifically, the thickness of the first case piece 21 and the thickness of the second case piece 22 are each preferably 50 μm to 200 μm, and more preferably 80 μm to 150 μm.

As described above, in the electric storage device 1, the first side wall portion 21b and the second side wall portion 22b are welded. Therefore, there is no need to provide a welding flange portion projecting outward in the can main body like the battery described in Patent Document 1. Therefore, the electric storage device 1 can be miniaturized.

Next, an example of a method for manufacturing the electric storage device 1 will be described.

First, a first case piece 21, a second case piece 22, and an electric storage device main body 3 are prepared.

Next, with the electric storage device main body 3 interposed between the first case piece 21 and the second case piece 22, the first and second case pieces 21 and 22, and the electric storage device main body 3 are disposed so that at least a part of the first side wall portion 21b of the first case piece 21 and at least a part of the second side wall portion 22b of the second case piece 22 overlap each other. In this state, the overlapping portion of the first side wall portion 21b and the second side wall portion 22b is laser-welded over the entire periphery, whereby the case 2 is produced (welding step). Performing the above step allows the electric storage device 1 to be completed.

It should be noted that, for example, a step of connecting terminals such as a positive electrode terminal and a negative electrode terminal to the electric storage device main body 3 and a step of forming openings in the case 2 for pulling the terminals out of the case 2 may be further performed.

In the welding step, a laser beam may be intermittently cast and spot-shaped welding traces may be continued so that adjacent spot-shaped welding traces overlap to form linear welded portions, or at least one of the laser beam source and the first and second case pieces 21 and 22 may be displaced while the laser beam is kept being cast and the irradiation position of the laser beam may be shifted to form linear welded portions.

In the welding step, it is preferable to perform laser welding with such intensity and time that the inner wall of the side wall positioned most inward of the side walls 21b and 22b of the first and second case pieces 21 and 22 does not deflect inwardly. In addition, it is more preferable to perform laser welding with such intensity and time that the depth of the welding trace does not reach the inner most wall of the overlapping side walls.

In the welding step, laser welding may be performed for each side surface. For example, welding on the first side surface, welding on the second side surface, welding on the third side surface, and welding on the fourth side surface of the first and second side wall portions 21b and 22b may be performed individually and sequentially. In that case, it is optional that in the order from which side surface of the first to fourth side surfaces a laser beam irradiation is performed. In addition, welding may be continuously performed on the four side surfaces while the first and second case pieces 21 and 22 are rotated.

In the present embodiment, an example of performing welding on the first side surface, welding on the second side surface, welding on the third side surface, and welding on the fourth side surface of the first and second side wall portions 21b and 22b individually and sequentially will be described.

When welding on the first side surface, welding on the second side surface, welding on the third side surface, and welding on the fourth side surface of the first and second side wall portions 21b and 22b are performed individually and sequentially, four linear welded portions in which continuous individual welding traces are formed. Specifically, the first to fourth welded portions 41 to 44 are formed. As shown in FIGS. 5 to 8, the first welded portion 41 is formed over the first side surface 2a of the case 2, and the first corner portion 51 (see FIGS. 5 and 6) and the second corner portion 52 (see FIGS. 7 and 8) positioned on both sides of the first side surface 2a. As shown in FIGS. 5, 6, 9, and 10, the second welded portion 42 is formed over the second side surface 2b of the case 2, and the first corner portion 51 (see FIGS. 5 and 6) and the third corner portion 53 (see FIGS. 9 and 10) positioned on both sides of the second side surface 2b. The third welded portion 43 is formed over the third side surface 2c of the case 2, and the second corner portion 52 (see FIGS. 7 and 8) and the fourth corner portion 54 (see FIGS. 11 and 12) positioned on both sides of the third side surface 2c. The fourth welded portion 44 is formed over the fourth side surface 2d of the case 2, and the third corner portion 53 (see FIGS. 9 and 10) and the fourth corner portion 54 (see FIGS. 11 and 12) positioned on both sides of the fourth side surface 2d. Since the first to fourth welded portions 41 to 44 are formed as described above, as shown in FIG. 6, in the first corner portion 51, the first end portion 41a of the first welded portion 41 and the first end portion 42a of the second welded portion 42 overlap each other. In the second corner portion 52, the second end portion 41b of the first welded portion 41 and the first end portion 43a of the third welded portion 43 overlap each other. In the third corner portion 53, the second end portion 42b of the second welded portion 42 and the first end portion 44a of the fourth welded portion 44 overlap each other. In the fourth corner portion 54, the second end portion 43b of the third welded portion 43 and the second end portion 44b of the fourth welded portion 44 overlap each other.

Meanwhile, when the corner portions 51 to 54 of the case 2 are irradiated with a laser beam, heat is more likely to be trapped than when the side surfaces 2a, 2b, 2c, and 2d of the case 2 are irradiated with a laser beam. Therefore, when laser welding is performed over the entire periphery of the case 2, damage to the corner portions tends to be large. Therefore, in the present embodiment, in the welding step, of the welded portions formed on the side surfaces of the case 2, a laser beam is cast so that the width of the welded portion formed on the corner portion of the case 2 (the width along the thickness direction of the case 2) is smaller than the width of the welded portion formed on the side surface of the case 2 (the width along the thickness direction of the case 2), and laser welding is performed. Therefore, of the welded portions formed on the side surfaces of the case 2, the width of the welded portion formed on the corner portion of the case 2 is smaller than the width of the welded portion formed on the side surface of the case 2. In order to narrow the width of the welded portion, it is necessary, for example, to reduce the intensity of the laser beam to be cast, or to lengthen the distance between the laser and the surface to be irradiated with the laser beam. That is, in order to narrow the width of the welded portion, it is necessary to reduce the intensity of the laser beam to be cast on that portion. Therefore, the corner portions 51 to 54 are not easily damaged. Therefore, an electric storage device 1 having excellent durability with corner portions having high strength can be achieved.

For example, as in the case where the electric storage device main body is a lithium ion battery or an electric double layer capacitor, the electric storage device main body may contain an electrolytic solution. In the electric storage device 1 including such an electric storage device main body 3, it is necessary to make the case 2 airtight. Therefore, it is necessary to reliably weld and join the first side wall portion 21b and the second side wall portion 22b over the entire periphery. Therefore, it is preferable that the first side wall portion 21b and the second side wall portion 22b are reliably welded over the entire periphery with the end portions of the welded portions overlapping with each other.

However, in order to overlap the end portions of the welded portions, it is necessary to irradiate the portions with the laser beam a plurality of times. Therefore, in the case, the portions irradiated with a laser beam a plurality of times may become fragile. Here, since the intensity of the laser beam to be cast on the side surface of the case is high, when the side surface of the case is irradiated with a laser beam a plurality of times and the end portions of the welded portions are overlapped with each other, a large amount of heat is applied to those portions and those portions become fragile, so that the case may be damaged.

On the other hand, in the present embodiment, in the welding step, laser welding is performed so that the tip portions of the welded portions overlap each other on the corner portions 51 to 54 of the case 2. Therefore, in the electric storage device 1, the welded portions 41 to 44 are formed so that the tip portions overlap each other on the corner portions 51 to 54 of the case 2. Specifically, in the welding step, laser welding is performed so that the tip portions of the welded portions 41 to 44 overlap each other on the respective corner portions 51 to 54 of the case 2. Therefore, in the electric storage device 1, the welded portions 41 to 44 are formed so that the tip portions overlap each other on the respective corner portions 51 to 54 of the case 2.

As described above, the corner portions 51 to 54 of the case 2 are irradiated with a laser beam of low intensity to form narrow welded portions. Therefore, when the corner portions 51 to 54 are irradiated with a laser beam a plurality of times so that the tip portions of the welded portions 41 to 44 overlap each other, the total damage applied to the corner portions 51 to 54 is small. Therefore, the damage on the case 2 can be reduced in the case where the corner portions are irradiated with a laser beam a plurality of times and the welded portions are overlapped so that the width of the welded portions is made narrow, as compared with in the case where the side surfaces are irradiated with a laser beam a plurality of times and the welded portions are overlapped. Therefore, the electric storage device 1 having excellent durability can be achieved.

In particular, for example, when the first and second case pieces 21 and 22 are formed of a thin metal plate having a thickness of about 50 μm to 200 μm, the case pieces 21 and 22 are likely to be damaged by irradiation with the laser beam. Therefore, it is effective to make the width of the welded portions formed on the corner portions narrower than the width of the welded portions formed on the side surfaces.

### DESCRIPTION OF REFERENCE SYMBOLS

1: electric storage device

2: case

2a: first side surface

2b: second side surface

2c: third side surface

2d: fourth side surface

3: electric storage device main body

21: first case piece

22: second case piece

21a: first wall portion

21b: first side wall portion

22a: second wall portion

22b: second side wall portion

41: first welded portion

41a: first end portion of first welded portion

41b: second end portion of first welded portion

42: second welded portion

42a: first end portion of second welded portion

42b: second end portion of second welded portion

43: third welded portion

43a: first end portion of third welded portion

43b: second end portion of third welded portion

44: fourth welded portion

44a: first end portion of fourth welded portion

44b: second end portion of fourth welded portion

51: first corner portion

52: second corner portion

53: third corner portion

54: fourth corner portion

1. An electric storage device comprising:
a case defining an interior space and having a first corner portion with a rounded shape in a plane view thereof, the case including:
a first case piece having a first wall portion, and a first side wall portion extending from an entire periphery of the first wall portion, and
a second case piece having a second wall portion, and a second side wall portion extending from an entire periphery of the second wall portion, the second side wall portion overlapping with the first side wall portion;
an electric storage device main body disposed in the interior space of the case; and
a weld extending over an entire periphery of the case in a portion thereof where the first side wall portion and the second side wall portion are overlapped with each other so as to weld the first case piece to the second case piece, wherein, a first width of a first welded portion on the first corner portion of the case is narrower than a second width of a second welded portion on a first side surface of the case.

2. The electric storage device according to claim 1, wherein the second welded portion on the first side surface of the case and a third welded portion on a second side surface of the case each include respective tip portions which overlap each other on the first corner portion of the case.

3. The electric storage device according to claim 1,
wherein the weld further includes
a third welded portion on a second side surface of the case,
a fourth welded portion on a third side surface of the case, and
a fifth welded portion on a fourth side surface of the case,
wherein the case further includes
a second corner portion,
a third corner portion, and
a fourth corner portion,
wherein a first side end portion of the second welded portion and a first side end portion of the third welded portion overlap on the first corner portion connecting the first side surface and the second side surface of the case,
wherein a second side end portion of the second welded portion and a first side end portion of the fifth welded portion overlap on the second corner portion connecting the first side surface and the fourth side surface of the case,
wherein a second side end portion of the third welded portion and a first side end portion of the fourth welded portion overlap on the third corner portion connecting the second side surface and the third side surface of the case, and
wherein a second side end portion of the fourth welded portion and a second side end portion of the fifth welded portion overlap on the fourth corner portion connecting the third side surface and the fourth side surface of the case.

4. The electric storage device according to claim 3, wherein
the second welded portion on the first side surface of the case and the third welded portion on the second side surface of the case each include respective tip portions which overlap each other on the first corner portion of the case,
the second welded portion on the first side surface of the case and the fifth welded portion on the fourth side surface of the case each include respective tip portions which overlap each other on the second corner portion of the case,
the third welded portion on the second side surface of the case and the fourth welded portion on the third side surface of the case each include respective tip portions which overlap each other on the third corner portion of the case,
the fourth welded portion on the third side surface of the case and the fifth welded portion on the fourth side surface of the case each include respective tip portions which overlap each other on the fourth corner portion of the case.

5. The electric storage device according to claim 4, wherein a width of welded portions on the second, third and fourth corner portions of the case are each narrower than a width of a welded portion on a side surface of the case adjacent thereto.

6. The electric storage device according to claim 3, wherein a width of welded portions on the second, third and fourth corner portions of the case are each narrower than a width of a welded portion on a side surface of the case adjacent thereto.

7. The electric storage device according to claim 1, wherein each of the first and second case pieces is a metal plate having a thickness of 50 μm to 200 μm.

8. The electric storage device according to claim 1, wherein the electric storage device main body contains an electrolytic solution.

9. A method for manufacturing an electric storage device that includes a case having a first corner portion with a rounded shape in a plane view thereof and an electric storage device main body disposed inside the case, the method comprising:
disposing a first case piece including a first wall portion and a first side wall portion extending from an entire periphery of the first wall portion and a second case piece including a second wall portion and a second side wall portion extending from an entire periphery of the second wall portion so that the first side wall portion and the second side wall portion overlap each other;
laser-welding an overlapping portion of the first side wall portion and the second side wall portion over an entire periphery of the case so that a first width of a first welded portion formed on the first corner portion of the case is smaller than a second width of a second welded portion formed on a side surface of the case.

10. The method for manufacturing an electric storage device according to claim 9, wherein the laser-welding is performed so that a first tip portion of the second welded portion on the first side surface of the case and a second tip portion of a third welded portion on a second side surface of the case overlap each other on the first corner portion of the case.

11. The method for manufacturing an electric storage device according to claim 9, wherein the laser-welding is performed such that:
a third welded portion is formed on a second side surface of the case,
a fourth welded portion is formed on a third side surface of the case,
a fifth welded portion is formed on a fourth side surface of the case,
a first side end portion of the second welded portion and a first side end portion of the third welded portion overlap on the first corner portion connecting the first side surface and the second side surface of the case,
a second side end portion of the second welded portion and a first side end portion of the fifth welded portion overlap on the second corner portion connecting the first side surface and the fourth side surface of the case,
a second side end portion of the third welded portion and a first side end portion of the fourth welded portion overlap on the third corner portion connecting the second side surface and the third side surface of the case, and
a second side end portion of the fourth welded portion and a second side end portion of the fifth welded portion overlap on the fourth corner portion connecting the third side surface and the fourth side surface of the case.

12. The method for manufacturing an electric storage device according to claim 11, wherein the laser-welding is performed such that:
the second welded portion on the first side surface of the case and the third welded portion on the second side surface of the case each include respective tip portions which overlap each other on the first corner portion of the case,
the second welded portion on the first side surface of the case and the fifth welded portion on the fourth side surface of the case each include respective tip portions which overlap each other on the second corner portion of the case,
the third welded portion on the second side surface of the case and the fourth welded portion on the third side surface of the case each include respective tip portions which overlap each other on the third corner portion of the case,
the fourth welded portion on the third side surface of the case and the fifth welded portion on the fourth side surface of the case each include respective tip portions which overlap each other on the fourth corner portion of the case.

13. The method for manufacturing an electric storage device according to claim 12, wherein a width of welded portions on the second, third and fourth corner portions of the case are each narrower than a width of a welded portion on a side surface of the case adjacent thereto.
